(19) United States
(12) Patent Application Publication
(10) Pub. No.: US 2013/0042772 A1
(43) Pub. Date: Feb. 21, 2013

(54) PRINTING BLANKET

(71) Applicant: Kouji Muraoka, Fukui (JP)

(72) Inventor: Kouji Muraoka, Fukui (JP)

(21) Appl. No.: 13/583,348

(22) PCT Filed: Aug. 20, 2010
(86) PCT No.: PCT/JP2010/005140

§ 371 Date: Sep. 7, 2012

(30) Foreign Application Priority Data
Apr. 21, 2010 (JP) 2010-097738

(51) Int. Cl. B41F 17/00

(52) U.S. Cl. 101/35

(57) ABSTRACT

To provide a printing blanket that enables good and rapid printing on a nonlinear printing surface (e.g., a doughnut-shaped outer surface). A printing blanket 10 is ring-shaped in plan view and includes an attachment surface 1, an inward facing surface 2, an outward facing surface 3, the inward and outward facing surfaces 2 and 3 being protruding surfaces, and ridge lines 4 which smoothly connect the inward facing surface 2 and the outward facing surface and which are substantially arc-shaped in section. A circle connecting the ridge lines 4 serves as a pitch circle 5 having a curvature radius P5. The printing blanket is suitable for printing on a steering wheel 20 having a pitch circle 8 having a curvature radius P8 which substantially coincides with the curvature radius P5.

### TECHNICAL FIELD

The present invention relates to printing blankets, and in particular, relates to a printing blanket suitable for printing on a nonlinear printing surface.

### BACKGROUND ART

In pad printing, gravure printing, screen printing, and the like, devices to increase printing accuracy have been proposed. For example, the inventor of this application has disclosed an invention which achieves multi-color printing with increased printing accuracy using a printing pad and a relief printing original plate in combination (refer to Patent Literature 1, for example).

### CITATION LIST

### Patent Literature

Patent Literature 1: Japanese Unexamined Patent Application Publication No. 2-239972 (pp. 8-9, FIG. 3)

### SUMMARY OF INVENTION

### Technical Problem

A printing blanket (hereinafter, referred to as the “blanket”) used for printing disclosed in Patent Literature 1 is substantially triangular prism-shaped or substantially pentagonal prism-shaped such that specific ridge lines (hereinafter, referred to as the “top”) are smoothly connected and side surfaces sandwiching the ridge lines are protruding surfaces. The blanket is pressed against a flat or linearly curved surface (hereinafter, referred to as the “printing surface”) of a printing material such that ink on the blanket is transferred to the printing surface, thus achieving printing. In this case, the axis of the printing surface (outer surface or inner surface of a cylinder or the like) is parallel to the longitudinal direction of the blanket.

For example, assuming that the printing surface is not linear, for example, the printing surface is a doughnut-shaped outer surface (e.g., a steering wheel of a car), when the blanket is pressed against the printing surface such that the longitudinal direction of the blanket is parallel to a tangent line to the circumference (or perpendicular to a radial line) at a predetermined point, the top of the blanket is separated from the highest part of the printing surface in the radial direction in a position apart from the predetermined point.

Specifically, in the case where the top of the blanket is allowed to substantially coincide with the highest part (corresponding to the position of the North Pole in section) of the printing surface in the vicinity of a predetermined point, the side surfaces of the blanket are first pressed against an outward facing portion of the printing surface in a position apart from the predetermined point. Second, the side surfaces of the blanket are gradually pressed against an inward facing portion of the printing surface over the highest part of the printing surface.

Accordingly, air does not tend to be squeezed out of the interface between the blanket and the printing surface, so that the air remains between the blanket and the printing surface. Disadvantageously, this leads to poor printing.

To achieve good printing, the length of the blanket has to be reduced and printing (pressing the blanket) has to be performed many times while the position of the blanket is being shifted in the circumferential direction. Disadvantageously, this leads to a complicated printing operation. The printing operation is delayed.

The present invention has been made to solve the above-described disadvantages and provides a printing blanket that enables good and rapid printing on a nonlinear printing surface (e.g., a doughnut-shaped outer surface).

### Solution to Problem

(1) A printing blanket according to the present invention includes an elastic body which is nonlinear in plan view and which has a pair of side surfaces arranged in a substantially V-shape in side view such that the side surfaces are smoothly connected.

(2) Furthermore, the pair of side surfaces may be protruding surfaces which protrude laterally. The pair of side surfaces may be connected by ridge lines which are substantially arc-shaped in section.

(3) Furthermore, the printing blanket may be used for printing on a printing surface which is a protruding or recessed surface in side view and is ring-shaped or arc-shaped in plan view.

The radius of curvature of a pitch line connecting the central points of the ridge lines may substantially coincide with the radius of curvature of a pitch line connecting the lowest points of the protruding surface of the printing material or a pitch line connecting the lowest points of the recessed surface thereof.

### Advantageous Effects of Invention

(i) Since the printing blanket according to the present invention is nonlinear in plan view, the “ridge lines” in the position where the pair of side surfaces are smoothly connected are simultaneously pressed against a printing material, which is nonlinear in plan view, upon printing. Accordingly, air is squeezed out of the interface between the printing blanket and a printing surface to prevent the air from remaining between the printing blanket and the printing surface. Advantageously, this results in good printing.

(ii) Furthermore, since the front surface of the printing blanket has a “triangular rice ball”-like shape in section defined by the ridge line which is substantially arc-shaped in section, good printing can be achieved on a three-dimensional object (protruding surface or recessed surface).

(iii) Furthermore, upon printing on a doughnut-shaped printing surface (e.g., a steering wheel of a car), the radius of curvature of a pitch circle connecting the central points of the ridge lines of the printing blanket substantially coincides with the radius of curvature of a center line (corresponding to a pitch circle connecting the centers of substantially circular sections) of the steering wheel. First, the entire circumference of the circle connecting the ridge lines is simultaneously pressed against the entire circumference of a circle corresponding to the highest part of the steering wheel. Second, parts apart from the ridge lines are gradually pressed against parts apart from the highest part. Printing proceeds in substantially the same manner in any position in the circumferential direction.

Accordingly, the air is prevented from remaining between the printing blanket and the printing surface (steering wheel), thus enabling good printing. Furthermore, it is unnecessary to provide a plurality of printing blankets and perform printing multiple times in the circumferential direction. Advantageously, this leads to a simple and rapid printing operation.

### BRIEF DESCRIPTION OF DRAWINGS

FIG. 1 includes a plan view of a printing blanket according to Embodiment 1 of the present invention and a sectional view thereof.

FIG. 2 is a sectional view of a printing material for explanation of the printing blanket of FIG. 1.

FIG. 3 includes plan views of modifications of the printing blanket of FIG. 1.

### DESCRIPTION OF EMBODIMENTS

### Embodiment 1

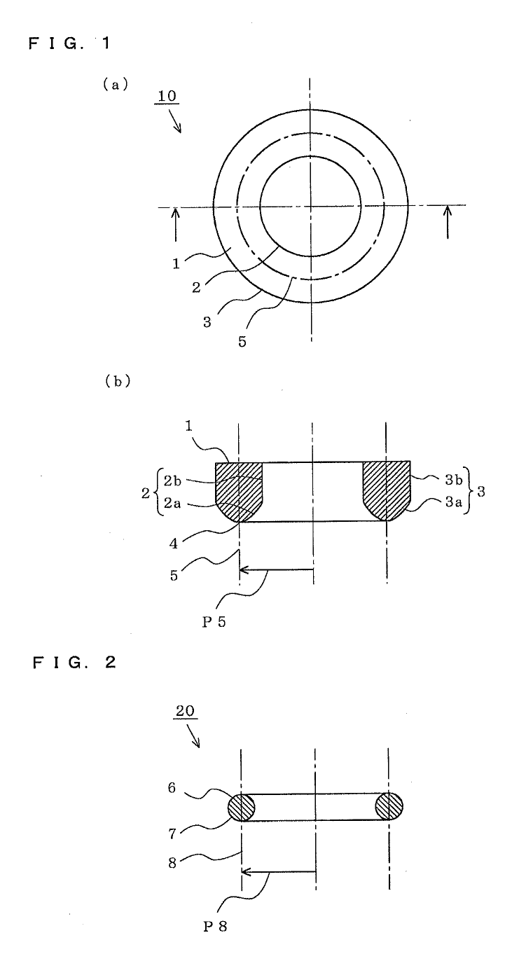

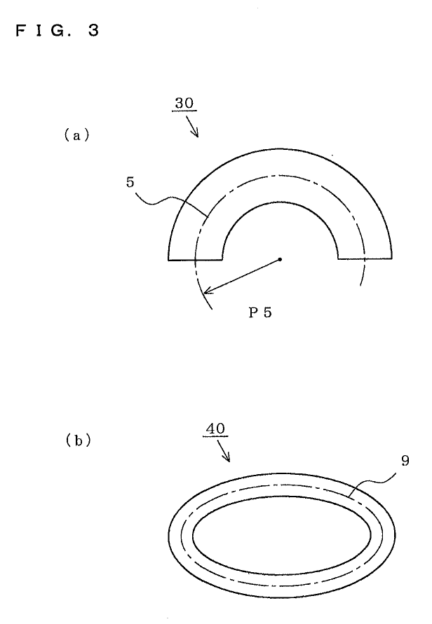

FIGS. 1 and 2 explain a printing blanket according to Embodiment 1 of the present invention. FIG. 1(a) is a plan view thereof, FIG. 1(b) is a sectional view thereof as viewed from the side, and FIG. 2 is a sectional view of a printing material as viewed from the side. Note that FIGS. 1 and 2 schematically illustrate the blanket and the printing material and the present invention is not limited to illustrated shapes (e.g., the ratio of an inside diameter to an outside diameter).

Referring to FIGS. 1(a) and (b), the printing blanket (hereinafter, referred to as the “blanket”), 10, is ring-shaped in plan view and includes an attachment surface 1 used for installation in a printing apparatus (not illustrated), an inward facing surface 2, an outward facing surface 3, the inward and outward facing surfaces 2 and 3 being protruding surfaces, and ridge lines 4 which are substantially arc-shaped in section and smoothly connect the inward facing surface 2 and the outward facing surface 3. Furthermore, the inward facing surface 2 includes an inward facing curved portion 2a having a relatively large radius of curvature and an inward facing flat portion 2b which is substantially flat. The outward facing surface 3 includes an outward facing curved portion 3a having a relatively large radius of curvature and an outward facing flat portion 3b which is substantially flat. The inward facing curved portion 2a joins with the outward facing curved portion 3a in the ridge lines 4. Since the inward facing flat portion 2b is substantially parallel to the outward facing flat portion 3b in section, the blanket 10 is substantially pentagon-shaped (like a home base) in section. Herein, a circle connecting the ridge lines 4 will be referred to as a “pitch circle 5” and let P5 denote the radius of curvature thereof.

Referring to FIG. 2, a steering wheel (corresponding to the printing material) 20 is circular in plan view and has a substantially circular cross section in side view. Specifically, the steering wheel 20 has an upper surface 6 which is approximately half a circle in section and a lower surface 7 which is approximately half the circle in section. Herein, a circle connecting the centers of the circular sections will be referred to as a “pitch circle 8” and let P8 denote the radius of curvature thereof.

In this case, the curvature radius P5 of the pitch circle 5 of the blanket 10 substantially coincides with the curvature radius P8 of the pitch circle 8 of the steering wheel 20.

Upon printing on the upper surface 6 using the blanket 10, therefore, the entire circumference of the circle connecting the ridge lines 4 of the blanket 10 is first simultaneously pressed against the entire circumference of a circle connecting the highest points (corresponding to the North Pole) of the upper surface 6 of the steering wheel 20. Second, the inward facing curved portion 2a and the outward facing curved portion 3a are gradually pressed against pars apart from the highest part of the upper surface 6 such that a contact portion approaches to the inward facing flat portion 2b and the outward facing flat portion 3b while increasing in area. Consequently, printing proceeds in substantially the same manner in any position in the circumferential direction (or any section perpendicular to the pitch circle 8).

This prevents air from remaining between the upper surface 6 of the steering wheel 20 and the inward and outward facing surfaces 2 and 3 of the blanket 10. Advantageously, good printing can be achieved. In particular, since the angle which the inward facing curved portion 2a forms with the outward facing curved portion 3a is relatively large (obtuse angle), the inward facing surface 2 and the outward facing surface 3 tend to be fitted to the outer surface of the steering wheel 20, such that the blanket 10 covers the entire upper half of the steering wheel 20 and part of the lower half thereof (or covers the Northern Hemisphere and reaches the Southern Hemisphere in the vicinity of the equator over the equator). If the angle which the inward facing curved portion 2a forms with the outward facing curved portion 3a is small (acute angle), the amount of downward movement of the blanket 10 will be increased, thus leading to an increase in volume of the blanket 10. The efficiency of printing would be lowered and the cost of the blanket would be increased.

The lower surface 7 of the steering wheel 20 can undergo similar printing.

Referring to FIG. 3(a), a printing blanket (hereinafter, referred to as the “blanket”) 30 is a half-ring-shaped (semicircular arc-shaped) in plan view and corresponds to approximately half the blanket 10. Accordingly, it is suitable for printing on a printing material which is semicircular arc-shaped in plan view. To perform printing on the steering wheel 20 which is ring-shaped, the same printing operation has to be performed twice in the circumferential direction. Good printing can be achieved as in the above description.

A blanket, serving as a piece obtained by substantially equally dividing the blanket 10 into three or four pieces, may be used instead of the blanket which serves as a piece obtained by substantially equally dividing the blanket 10 in two.

Referring to FIG. 3(b), a printing blanket (hereinafter, referred to as the “blanket”) 40 is elliptical in plan view. In other words, it is suitable for printing on a printing material which is elliptical in plan view. In this case, a pitch line 9 connecting ridge lines (not illustrated) of the blanket 40 is substantially congruent with a pitch line (not illustrated) connecting the highest points of the printing surface of the printing material or a pitch line (not illustrated) connecting the lowest points thereof.

The present invention does not limit the shape of a printing material in plan view to a circle or an ellipse. A printing material may have any shape. Furthermore, the printing surface of a printing material is not limited to a protruding surface. The printing surface may be a recessed surface. A pitch line connecting the highest points of the protruding surface or the lowest points of the recessed surface as the printing surface is substantially congruent with the pitch line connecting the ridge lines of the blanket 40.

### INDUSTRIAL APPLICABILITY

According to the present invention, since good printing can be achieved on a nonlinear printing material, the printing blanket is widely available for different shaped printing materials.

### REFERENCE SIGNS LIST

1 attachment surface

2 inward facing surface

3 outward facing surface

4 ridge line

5 pitch circle

6 upper surface

7 lower surface

8 pitch circle

9 pitch line

10 blanket

20 steering wheel

40 blanket

P5 curvature radius

P8 curvature radius

1. A printing blanket comprising an elastic body which is nonlinear in plan view and which has a pair of side surfaces arranged in a substantially V-shape in side view such that the side surfaces are smoothly connected.

2. The printing blanket of claim 1, wherein the pair of side surfaces are protruding surfaces which protrude laterally and the pair of side surfaces are connected by ridge lines which are substantially arc-shaped in section.

3. The printing blanket of claim 1,
wherein the printing blanket is used for printing on a printing surface which is a protruding or recessed surface in side view and is ring-shaped or arc-shaped in plan view, and
wherein the radius of curvature of a pitch line connecting the lowest points of the protruding surface or a pitch line connecting the lowest points of the recessed surface substantially coincides with the radius of curvature of a pitch line connecting the central points of the ridge lines.
